(19) United States
(12) Patent Application Publication
(10) Pub. No.: US 2016/0294431 A1
(43) Pub. Date: Oct. 6, 2016

(54) PERSONAL ELECTRONIC DEVICE SUPPORT

(71) Applicant: Charles C. Oney, Basin, WY (US)

(72) Inventor: Charles C. Oney, Basin, WY (US)

(21) Appl. No.: 15/083,577

(22) Filed: Mar. 29, 2016

Related U.S. Application Data
(60) Provisional application No. 62/177,963, filed on Mar. 30, 2015.

(51) Int. Cl. H04B 1/3888; A45F 5/00; A45C 11/00

(52) U.S. Cl. CPC H04B 1/3888; A45C 11/00; A45F 5/00; A45C 2011/003

(57) ABSTRACT

A personal electronic device support may be provided. The support may include straps capable of securing the support around a user's legs. A personal electronic device may be secured to the support. The personal electronic device may be retained in a working orientation when the support secured to a user.

### PRIORITY CLAIM

This application claims priority to U.S. Provisional Application No. 62/177,963, filed Mar. 30, 2015, the contents of which are herein incorporated by reference in their entirety.

### BACKGROUND

Computers have evolved over time to provide portability, versatility, and comfort for users. Laptops, notebooks, and tablet variations, for example, are well suited for use in all environments, including when no desk or table is present. Users often use their appendages, laps, or other objects to orient such devices in a desirable position for use. However, supporting a laptop or similar device in this manner often results in a precarious balancing act or unstable working platform. This may detract from the comfort and productivity of a user.

### SUMMARY

According to at least one exemplary embodiment, a personal electronic device support may be provided. The personal electronic device support may include a support base. The personal electronic device support may further include at least two securing straps projecting outwardly from opposite sides of the support base. The securing straps may have fasteners for securing together. The personal electronic device support may also include at least two securing pockets disposed on a front face of the support base. The securing pockets may be capable of engaging a personal electronic device. The personal electronic device support may also include a device strap disposed on a front face of the support base proximate a top edge and capable of securing the personal electronic device.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is a front plan view of an exemplary embodiment of a personal electronic device support;

FIG. 2 is a back plan view of an exemplary embodiment of a personal electronic device support;

FIG. 3 is a front perspective view of an exemplary embodiment of a personal electronic device support;

FIG. 4 is a front perspective view of an exemplary embodiment of a personal electronic device support with environment;

FIG. 5 is a rear perspective view of an exemplary embodiment of a personal electronic device support with environment;

FIG. 6 is a front perspective view of an exemplary embodiment of a personal electronic device support with environment; and

FIG. 7 shows a series of stages of use of an exemplary embodiment of a personal electronic device support with environment.

### DETAILED DESCRIPTION OF THE EMBODIMENTS

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

According to some exemplary embodiments, a personal electronic device support 100 may be provided. Support 100 may be used to secure and stabilize a laptop or similar personal electronic device to a user's body in a working orientation. Support 100 may be made of any desired material, such as neoprene, nylon, or similar fabrics and materials as would be understood by a person having ordinary skill in the art. Support 100 may further be made of elastic material or include elastic components, such as elastic edges 160.

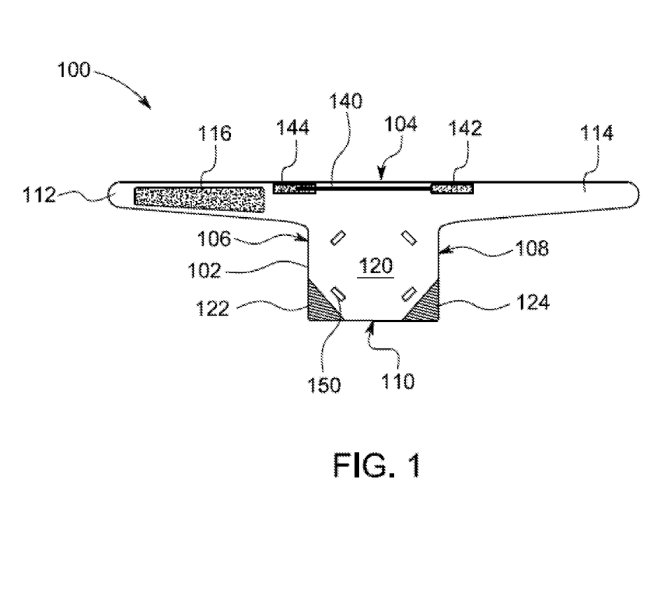

Referring to the Figures generally, particularly exemplary FIG. 1, support 100 may have a support base 102 and securing straps 112, 114. In an exemplary embodiment, support base 102 may be substantially rectangular. In alternative exemplary embodiments, support base 102 may optionally be shaped and sized to correspond with a desired personal electronic device, laptop or similar device, as would be understood by a person having ordinary skill in the art. Straps 112, 114 may project from support base 102 and may be capable of wrapping around a user or object. Straps 112, 114 may removably fasten to each other to secure around a user or object. In at least one exemplary embodiment, support base 102 may have a top edge 104, a left edge 106, a right edge 108, and a bottom edge 110. Straps 112, 114 may be elongated flanges projecting outwardly from opposing edges 106, 108 proximate top edge 104. Straps 112, 114 may optionally be formed integrally with support base 102 or may be affixed to support base 102. Straps 112, 114 may have a top edge coinciding with top edge 104. Top edge 104 may optionally be ergonomically curved to correspond with an object or body part to be engaged. In an exemplary embodiment, the top edge of straps 112, 114 may curve upward as they project away from support base 102.

Support 100, including support base 102 and straps 112, 114, may have a front face 120, which may be capable of engaging a laptop or similar device. One of straps 112, 114 may have a fastening area or member 116 disposed on its front face 120. Support 100 may further include at least one securing pocket on its front face 120 for engaging a laptop or similar device. In some exemplary embodiments, support 100 may include securing pockets 122, 124 at opposing corners along bottom edge 110 of support base 102. Securing pockets 122, 124 may open facing substantially toward a central area of support base 102. Therefore, portions of a laptop or similar device resting on support base 102 may be tucked into securing pockets 122, 124. In an exemplary embodiment, corners of a laptop resting on support base 102 may be tucked into pockets 122, 124.

Additionally, support 100 may include a device strap 140, which may be capable of engaging a supported device, such as a laptop. Device strap 140 may be, for example, an elastic cord, band, or strap. Device strap 140 may be permanently affixed to support 100 at a fixed end 142 and may be capable of removably affixing to support 100 at a detachable end 144. Device strap 140 may optionally be removably affixed at both ends 142, 144. Device strap 140 may optionally be affixed using stitching, adhesive, hook and loop type fasteners, buttons, ties, or other fasteners as would be understood by a person having ordinary skill in the art. In some exemplary embodiments, device strap 140 may enclose a portion of a device between the strap 140 and the support 100. For example, device strap 140 may traverse a hinged portion of a laptop, securing the base of the laptop to support base 102 proximate the hinge and further supporting the hinge of the laptop.

Support 100 may further optionally include elastic retaining strips 150 on front face 120. Elastic retaining strips 150 may be disposed on front face 120 to secure portions of a device, such as a tablet. In an exemplary embodiment, elastic retaining strips 150 may be capable of retaining the four corners of a tablet device. Elastic retaining strips 150 may be elastic strips secured at the ends to support 100 and capable of stretching over the corners of a device to be secured, as would be understood by a person having ordinary skill in the art.

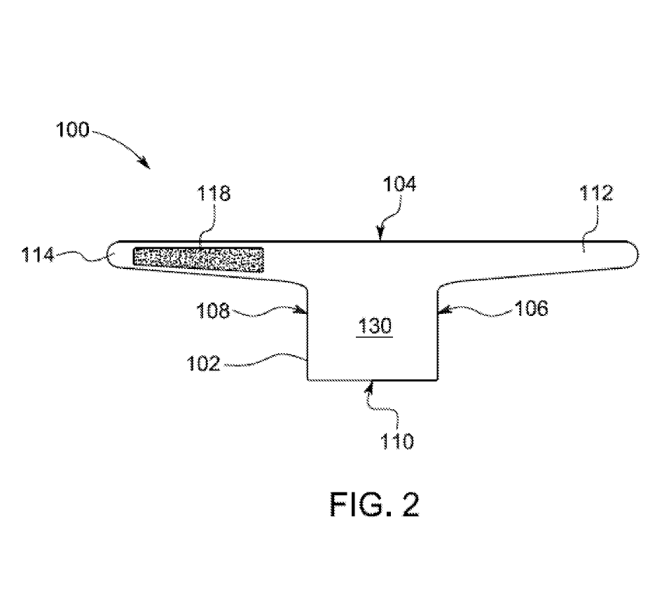

Now referring to exemplary FIG. 2, support 100, including support base 102 and straps 112, 114, may have a back face 130, which may be capable of engaging or abutting a user's body or an object for support. One of straps 112, 114 may have a fastening area or member 118 disposed on its back face 130, which may correspond to and engage fastening area or member 116. Fastening members 116, 118 may include hook and loop type fasteners, adhesives, ties, buttons, buckles, or other fasteners as would be understood by a person having ordinary skill in the art. In some embodiments, fastening members 116, 118 may be capable of engaging the surface material of support 100 in addition to each other.

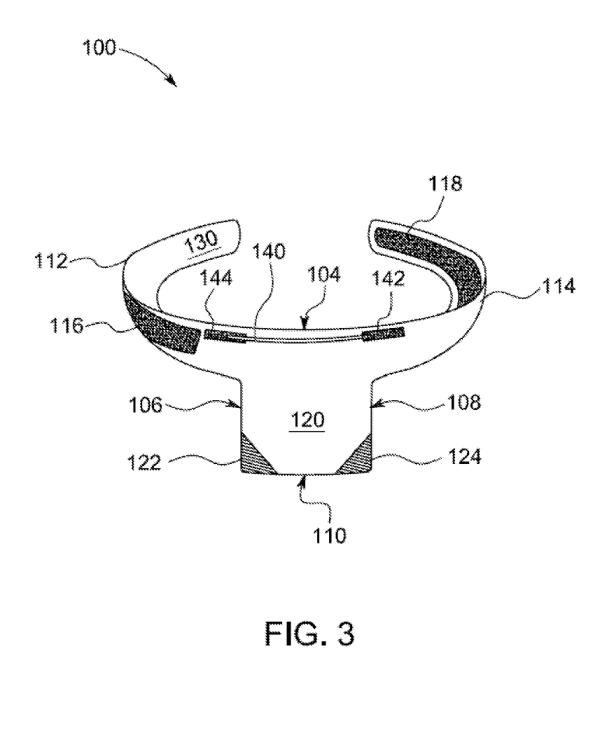

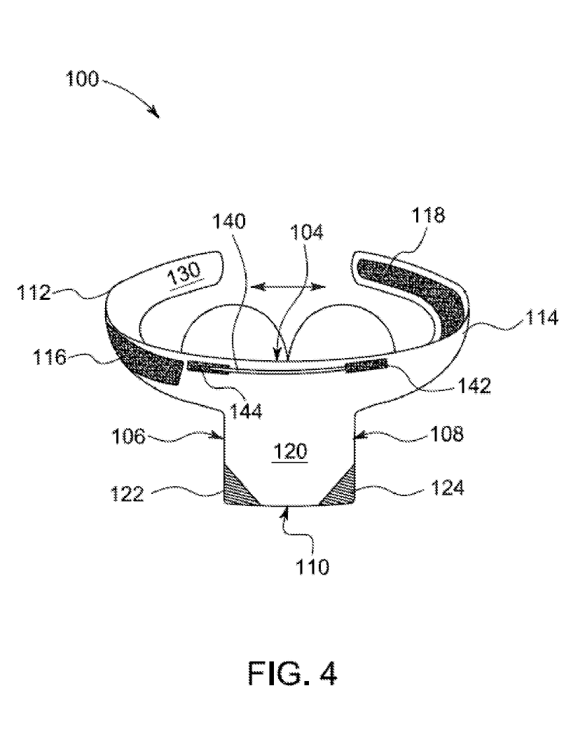

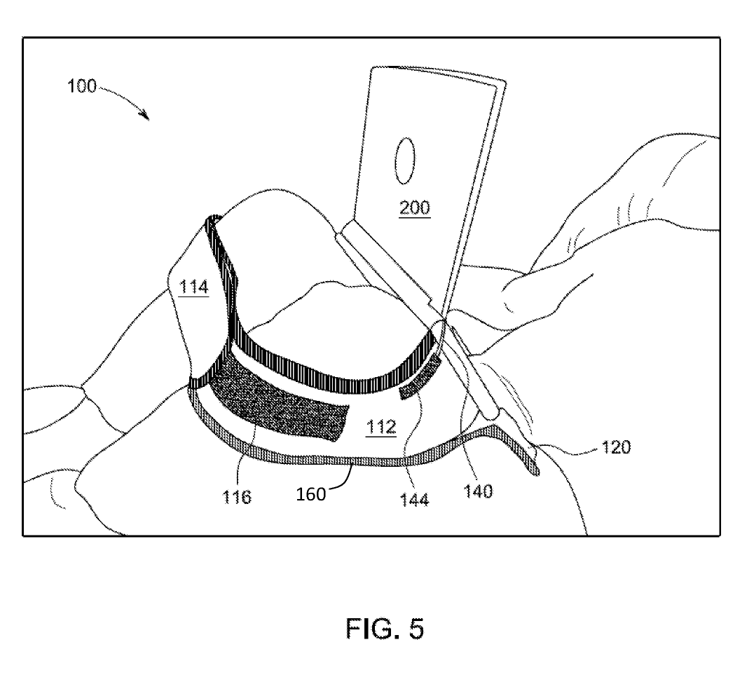

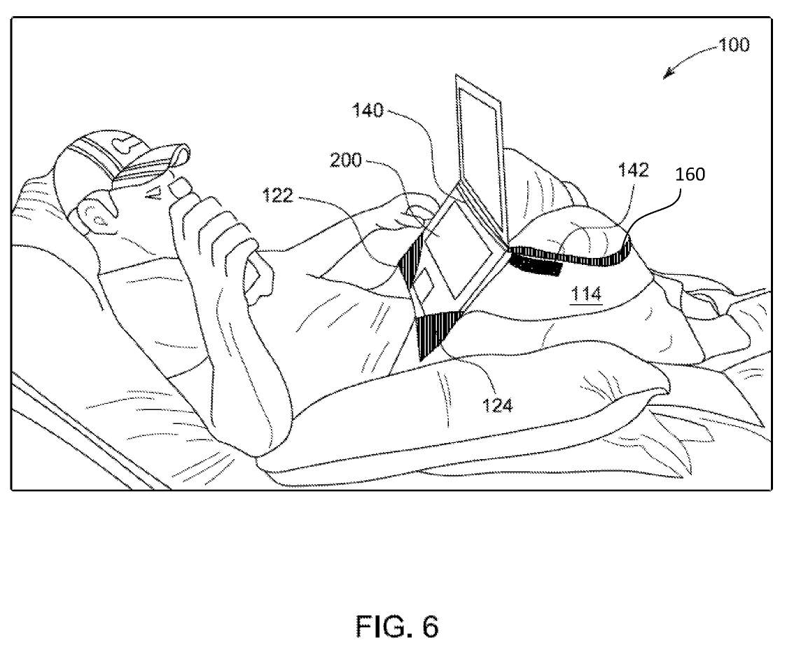

Now referring to exemplary FIGS. 3-7, a personal electronic device support 100 may be shown in an in-use orientation. Exemplary FIG. 4 may show straps 112, 114 wrapping around a user's legs, such that front face 120 is oriented on a user's thighs, facing the user. Exemplary FIGS. 5 and 6 may show straps 112, 114 engaged together, securing support 100 on a user's legs in a desired orientation. Device strap 140 may also be shown securing a device 200, as described above.

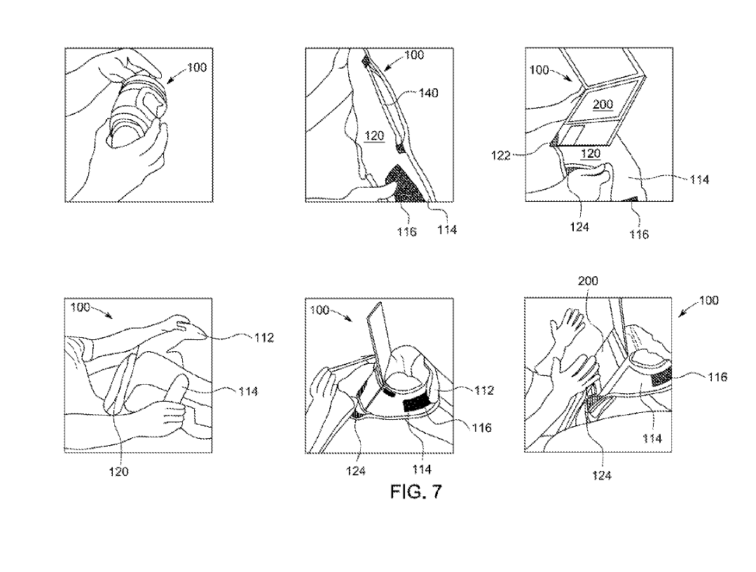

Now referring to exemplary FIG. 7, a series of steps for using the personal electronic device support 100 may be provided in the depictions. The personal electronic device support 100 may be removed from a drawstring storage bag. Support 100 may be stored in a rolled-up orientation. Fasteners 116, 118 may be used to secure support 100 in a rolled-up orientation. Alternatively, a separate strap may be utilized to retain support 100 in a rolled-up orientation. A user may slide a device 200 into pockets 122, 124 or into elastic retaining strips 150. A user may orient in a comfortable seated, reclined position with their knees up and feet flat. The support may be rested on their legs such that the laptop is resting on their lap. The straps 112, 114 may then be wrapped around their knees and secured together. The laptop may then be ready for use and the device strap 140 may be secured over the device for added security. A user may further secure the desired orientation by moving their feet outward, stretch the support 100. Support 100 may be removed and stored in reverse order, as would be understood by a person having ordinary skill in the art.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A personal electronic device support comprising:
a support base;
at least two securing straps projecting outwardly from opposite sides of the support base, the securing straps having fasteners for securing together;
at least two securing pockets disposed on a front face of the support base and configured to engage a personal electronic device; and
a device strap disposed on a front face of the support base proximate a top edge and configured to secure the personal electronic device.

2. The support of claim 1, further comprising at least one elastic retaining strip disposed on the front face of the support base and configured to retain a personal electronic device.

3. The support of claim 2, further comprising four elastic retaining strips, each configured to engage a corner of a tablet device.

4. The support of claim 1, wherein the support is made of neoprene.

5. The support of claim 1, wherein the at least two securing straps comprises a first securing strap projecting outwardly from a left edge of the support base proximate the top edge of the support base and a second securing strap projecting outwardly from a right edge of the support base proximate the top edge of the support base.

6. The support of claim 5, wherein one of the first and second securing straps comprises a fastener on a front surface and the remaining of the first and second securing straps comprises a fastener on a back surface.

7. The support of claim 1, wherein the fasteners are hook and loop fasteners.

8. The support of claim 1, wherein the device strap comprises an elastic cord permanently affixed to the front surface of the support base on a first end and removably securable to the front surface of the support base on a second end.

9. The support of claim 1, wherein the securing straps and support base are integrally formed.

10. The support of claim 1, further comprising elastic edges.

11. The support of claim 1, wherein the at least two securing pockets comprise a first securing pocket disposed on the support base proximate a lower left corner and a second securing pocket disposed on the support base proximate a lower right corner, wherein the first and second securing pockets open toward a central area of the support base.
